(19) United States
(12) Patent Application Publication
(10) Pub. No.: US 2025/0373541 A1
(43) Pub. Date: Dec. 4, 2025

(54) HIGH-PERFORMANCE COMMUNICATION LINK AND METHOD OF OPERATION

(71) Applicant: Aviatrix Systems, Inc., Santa Clara, CA (US)

(72) Inventors: Shiva Sundarrajan, Santa Clara, CA (US); Praveen Raju Kariyanahalli, Santa Clara, CA (US); Andrey Terentyev, Santa Clara, CA (US); Praveen Vannarath, Santa Clara, CA (US)

(73) Assignee: Aviatrix Systems, Inc., Santa Clara, CA (US)

(21) Appl. No.: 18/876,185

(22) PCT Filed: Jun. 17, 2023
(86) PCT No.: PCT/US2023/025643

§ 371 Date: Dec. 17, 2024

Related U.S. Application Data
(60) Provisional application No. 63/353,498, filed on Jun. 17, 2022.

(51) Int. Cl. H04L 45/24; H04L 61/2521

(52) U.S. Cl. CPC H04L 45/245; H04L 61/2528

(57) ABSTRACT

Embodiments of the disclosure relate to a secure, high-performance communication link that relies on single network, multiple logical port addressing. Embodiments of an infrastructure are associated with a high-performance communication link that allows for distribution of network traffic across multiple interconnects using a single network address with different logical network port addressing. This high-performance communication link supports data traffic across different processing logic units residing within a destination computing device.

### CROSS-REFERENCE TO RELATED APPLICATIONS

This application claims the benefit of priority on U.S. Patent Application No. 63/353,498 filed Jun. 17, 2022, the entire contents of which are incorporated by reference herein.

### FIELD

Embodiments of the disclosure relate to the field of networking. More specifically, one embodiment of the disclosure relates to a secure, high-performance communication link that relies on single network, multiple logical port addressing.

### GENERAL BACKGROUND

Over the past few years, cloud computing has provided Infrastructure as a Service (IaaS), where components have been developed to leverage and control native constructs for all types of public cloud networks, such as AMAZON® WEB SERVICES (AWS), MICROSOFT® AZURE® Cloud Services, ORACLE® virtual cloud network, GOOGLE® Cloud Services, or the like. These components may operate as part of a software-defined overlay network infrastructure, namely a network configured to control the transmission of messages between resources maintained within different virtual networking infrastructures of a public cloud network.

More specifically, the overlay network may be configured to support ingress and egress communications at selected virtual networking infrastructures, namely gateways sometimes referred to as “spoke gateways” and “transit gateways. These gateways leverage a secure networking protocol, such as Internet Protocol Security (IPSec) for example, for gateway-to-gateway connectivity in the transmission of User Datagram Protocol (UDP) Encapsulated Security Payload (ESP) packets. However, IPSec has an inherent performance limitation, where a single IPSec UDP connection cannot provide more than approximately one gigabit per second (˜1 Gbps) of data throughput. While throughput limitations may be addressed through the use of multiple Internet Protocol (IP) addresses, this solution may impose significant constraints on network operability, especially where IP addresses are not readily available and prior network provisioning has occurred where needed IP address ranges are unavailable.

Herein, IPSec is a set of protocols for establishing an encrypted connectivity channel between two computing devices each assigned a unique IP address. IPSec involves (i) key exchange & negotiation (IKE protocol) that runs on UDP ports 500/4500; and (ii) encrypted packet tunnel formation in accordance with Encapsulating Security Payload (ESP) protocol. ESP works over raw IP protocol similar to TCP/UDP/ICMP. However, due to widespread adoption of firewalls/network address translations, it is normally used in UDP-encapsulated tunnel mode using UDP port 4500. ESP can work in tunnel/S2S mode (carry whole IP packet) or transport/P2P mode (carry IP packet data).

Also, in LINUX® and other operating systems, packets of a single TCP or UDP connection are typically handled on specific processor cores of a multi-core system. Currently, when operating in accordance with IPSec protocol, the distribution of packets over a single connection across multiple processor cores at a destination computing device is troublesome, as the processor core is selected based on a hash computation of addressing information that includes IP addresses and port identifiers (e.g., port 4500). In accordance with RFC 3948 entitled “UDP Encapsulation of IPsec ESP Packets,” the IPSec protocol, when utilized by a single source with a static IP address, fails to provide entropy for IPSec encrypted traffic to be directed to different processor cores at the destination computing device. As a result, transmitted data from a source computing device is consistently directed to a specific processor core of the destination computing device. Due to the lack of distinctiveness within the addressing information, IPSec encrypted traffic is limited to approximately one gigabit per second (Gbps).

An alternative solution to the constraints associated with IPSec that does not depend on creation of additional IP addresses is needed.

### SUMMARY OF THE INVENTION

An embodiment of the claimed invention is directed to a high-performance communication link connecting a first computing device and a second computing device, the communication link comprising a plurality of interconnects between the first computing device and the second computing device.

A further embodiment of the claimed invention is directed to a high-performance communication link connecting a first computing device and a second computing device, wherein each of the first computing device and the second computing device comprises at least one network interface, and the at least one network interface includes at least one network interface controller.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1A is an exemplary embodiment of a high-performance communication link featuring multiple interconnects established between computing devices.

FIG. 1B is an exemplary embodiment of a 5-tuple address header of a message transmitted over the high-performance communication link of FIG. 1A.

FIG. 2A is an exemplary embodiment of a network interface controller (NIC) interacting with NIC queues and processing logic units deployed within the second computing device of FIG. 1A.

FIG. 2B is an exemplary embodiment of hashing logic that performs operations on meta-information of a message, inclusive of the logical port identifiers, for determination of Network Interface Controller (NIC) queues at the second computing device to receive the message.

FIG. 3 is a first exemplary embodiment of the message flow over the interconnects forming the high-performance communication link of FIG. 1A where NIC queue assignment is based assigned logical source port identifiers.

FIG. 4 is a second exemplary embodiment of the message flow over the interconnects forming the high-performance communication link of FIG. 1A where NIC queue assignment is based on assigned logical destination port identifiers.

FIG. 5 is an exemplary logical representation of communications over the high-performance communication link of FIG. 1A as perceived by the computing devices.

FIG. 6 is an exemplary embodiment of the operability of Network Address Translation (NAT) logic of the first (source) computing device supporting the high-performance communication link of FIG. 5.

FIG. 7 is an exemplary embodiment of the operability of Network Address Translation (NAT) logic of the second (destination) computing device supporting the high-performance communication link of FIG. 5.

FIG. 8 is an exemplary embodiment of an overlay network operating in cooperation with cloud architecture and featuring the computing devices deployed within multiple virtual private cloud networks with high-performance communication links between the computing devices.

FIG. 9A is an illustrative embodiment of operability of the high-performance communication link of FIG. 1A deployed as part of the overlay network of FIG. 8 between the first computing device operating as a spoke gateway and the second computing device operating as a transit gateway.

FIG. 9B is an illustrative embodiment of operability of the high-performance communication link of FIG. 1A deployed as part of the overlay network of FIG. 8 between the first computing device operating as a first transit gateway and deployed within a first public cloud network and the second computing device operating as a second transit gateway and deployed within a second public cloud network.

### DETAILED DESCRIPTION

Embodiments of an infrastructure are associated with a high-performance communication link that allows for distribution of network traffic across multiple interconnects using a single network address with different logical network port addressing. This high-performance communication link supports data traffic across different processing logic units (e.g., different processor cores) residing within a destination computing device. Herein, according to one embodiment of the disclosure, these high-performance communication links may be deployed as part of a software-defined single cloud or multi-cloud overlay network. Stated differently, the high-performance communication links may be part of an overlay network that supports communications between computing devices that reside within different virtual networking infrastructures that may be deployed within the same public cloud network or deployed within different public cloud networks.

As an illustrated example, the computing devices may constitute gateways, such as a “spoke” gateway residing within a first virtual networking infrastructure and a “transit” gateway included as part of a second virtual networking infrastructure for example. Each gateway may constitute virtual or physical logic that features data monitoring and/or data routing functionality. Each virtual networking infrastructure may constitute a virtual private network deployed within an AMAZON® WEB SERVICES (AWS) public cloud network, a virtual private network deployed within a GOOGLE® CLOUD public cloud network, a virtual network (VNet) deployed within a MICROSOFT® AZURE® public cloud network, or the like. As described below, each of these types of virtual networking infrastructures, independent of the cloud service provider, shall be referred to as a “virtual private cloud network” or “VPC.”

Herein, the high-performance communication link may be created by establishing a plurality of interconnects between the computing devices. According to one embodiment of the disclosure, these interconnects may be configured in accordance with a secure network protocol (e.g., Internet Protocol Security “IPSec” tunnels), where multiple IPSec tunnels may run over different ports to achieve increased aggregated throughput. For this embodiment, the high-performance communication link may achieve increased data throughput by substituting a logical (ephemeral) network port for an actual network (source or destination) port such as port 500 or 4500 utilized for IPSec data traffic. The logical port may be included as part of the 5-tuple header for messages exchanged between the first computing device and the second computing device.

To ensure substantially equal distribution of data traffic, processed by the destination computing device and received via the interconnects (e.g., encrypted message tunnels such as IPSec tunnels), content from the data traffic (e.g., 5-tuple header from messages forming the data traffic) may undergo operations to produce a result. The result is relied upon for selection of a processing logic unit targeted to receive the incoming data traffic. More specifically, a network interface controller (NIC) for the second computing device may be configured to receive data traffic addressed by a destination IP address assigned to the second computing device over the high-performance communication link, but enables scaling by substituting the actual source port or destination port with a logical source port or destination port residing within a selected logical port range. The NIC performs operations on content, inclusive of the chosen logical (source or destination) port, to select a (NIC) queue to receive the data traffic. The logical port provides pseudo-predictive entropy in directing data traffic to different NIC queues each associated with a particular processing logic unit,

The selection of the NIC queue may be based on a result from a one-way hash operation conducted on the meta-information associated with the data traffic (e.g., header information inclusive of the logical source or destination port number). Each queue is uniquely associated with a processing logic unit associated with the second computing device. Hence, by directing the data traffic to different NIC queues, this communication scheme effectively directs the data traffic to different processing logic units thereby increasing the aggregate data throughput over the high-performance communication link.

It is contemplated that the number of interconnects (R) may be greater than or equal to the number of processing logic units (M), which are deployed within a destination computing device and are configured to consume IPSec data traffic. For example, the number of interconnects (e.g., “R” IPSec tunnels) may be equal to or exceed the number of processing logic units (R≥M) deployed at the destination computing device to ensure saturation and usage of each of the NIC queues to optimize data throughput. The selection of the logical port range, which may be a continuous series of port identifiers (e.g., 4501-4516) or discrete port numbers (e.g., 4502, 4507, etc.), may be determined in advance based on test operations performed by the NIC to generate a logical port range that ensues routing to each of the processing logic units within the second computing device. As an illustrative example, these operations may correspond to one-way hash operation to convert content of the 5-tuple address for an incoming message into a static result for use in selection of a NIC queue to receive the incoming message. Stated differently, determined through a hash function, the result is correlated to a logical port identifier residing within the logical port range to ensure that all of the NIC queues are accessible based on at least one logic port within the logical port range.

In accordance with another embodiment of the disclosure, a distribution of load (data traffic) across the high-performance communication link to multiple processing logic units may be accomplished through network address translation (NAT) logic that operates as a process within or a separate process from the NIC. For handling incoming data traffic, the NAT logic may be configured with access to one or more data stores, which are configured to maintain (i) a first mapping between peer IP address/logical port combinations and their corresponding ephemeral network address/actual port combinations and (ii) a second mapping between the ephemeral network address/actual port combinations and peer IP address/actual port combinations. Additionally, for handling outgoing data traffic, the NAT logic may be configured with access to a mapping between the logical port and specific processing logic unit (or NIC queue at a destination). This address translation scheme allows communications over the high-performance communication link to rely on a single IP address assigned to the destination computing device despite multiple interconnects (e.g., IPSec tunnels), with the actual source and/or destination port identifiers being substituted with a logical source port identifier and/or a logical destination port identifier to assist in (NIC) queue selection at the destination computing device.

As referenced above, this logical port substitution followed by subsequent ephemeral address translation based on the substituted logical port may be relied upon to determine and select a NIC queue to receive the messages associated with the incoming data traffic from the source computing device. By distributing content of data traffic through selection of different logical ports, higher aggregated data throughput between computing devices may be achieved.

The NAT logic is configured to overcome throughput problems experienced by tenants who have already provisioned their VPC networks in certain way and now want to add high-performance communication links. First, the public IP addresses may not be readily available and adaptation of additional functionality, such as horizontal auto-scale for example, may be difficult to deploy as a new set of IP addresses for each scaled-out gateway is needed.

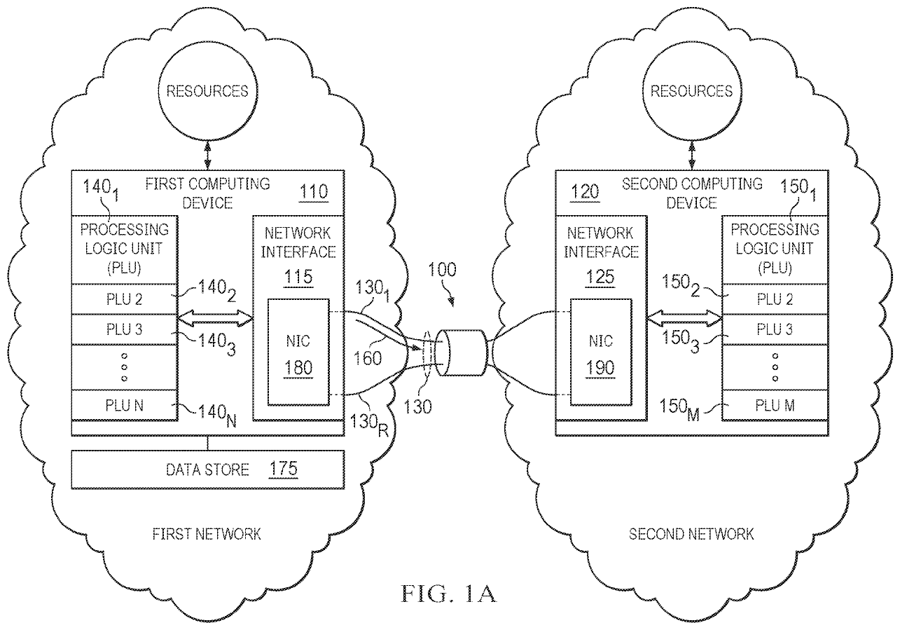

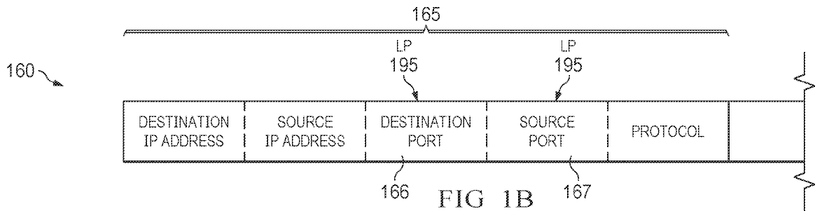

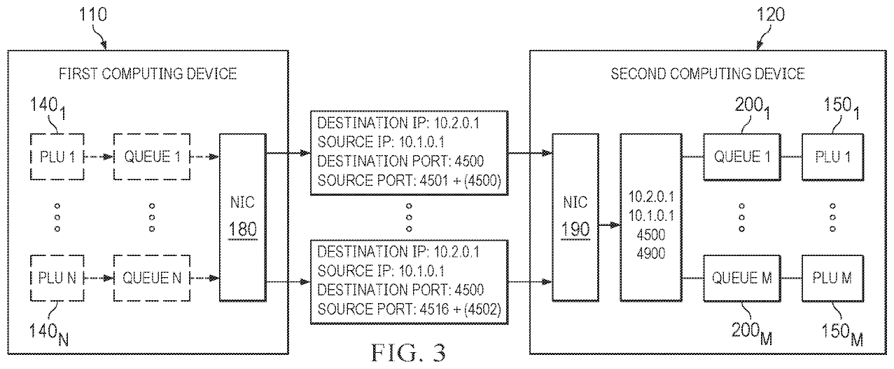

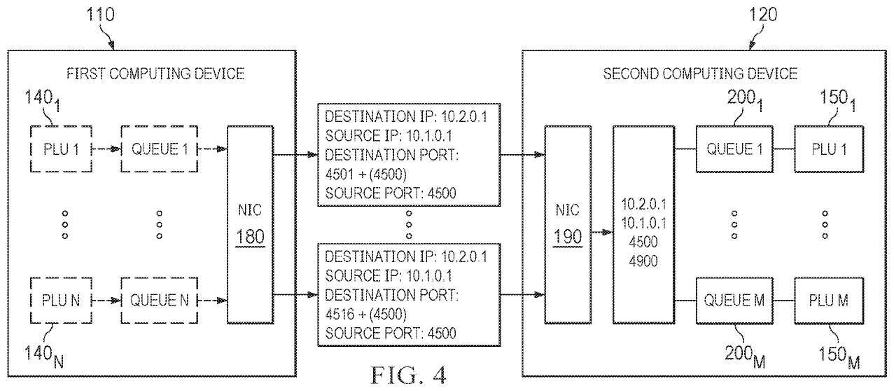

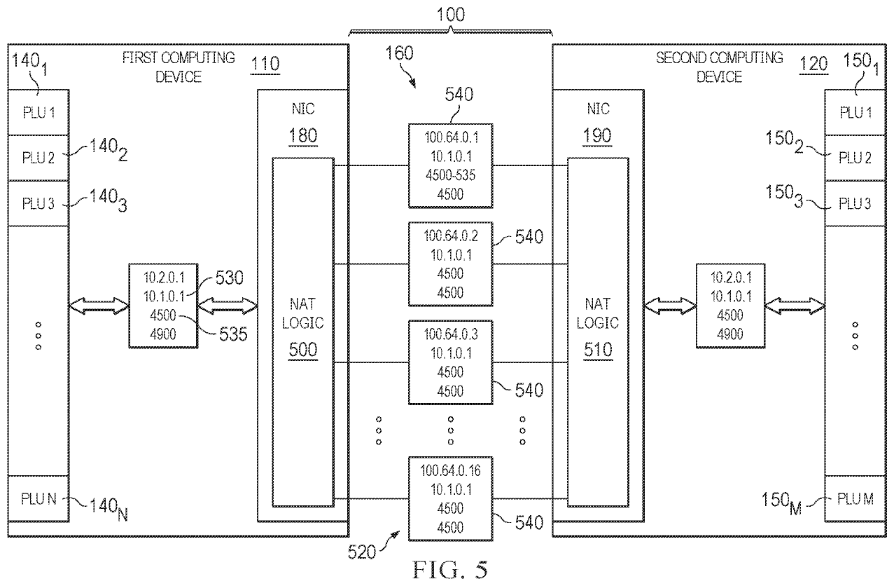

Therefore, in accordance with a first embodiment of the disclosure, the high-performance communication link can be accomplished using different (logical) source ports, destination ports or both as shown in FIGS. 1A-4. In particular, FIG. 3 provides a representative diagram of communications over the high-performance communication link that utilize the same destination IP address but different logical source ports residing within logical port range 4501-4516 while FIG. 4 provides a representative diagram of communications over the high-performance communication link that utilize the same destination IP address but different logical destination ports residing within logical port range 4501-4516. In accordance with a second embodiment of the disclosure, FIGS. 5-7 provide representative diagrams illustrating the establishment of the high-performance communication link through ephemeral network addressing, which are generated based on the logical destination ports and content of the ephemeral network address is relied upon for selection of a processing logic unit from a plurality of processing logic units deployed within the destination computing device.

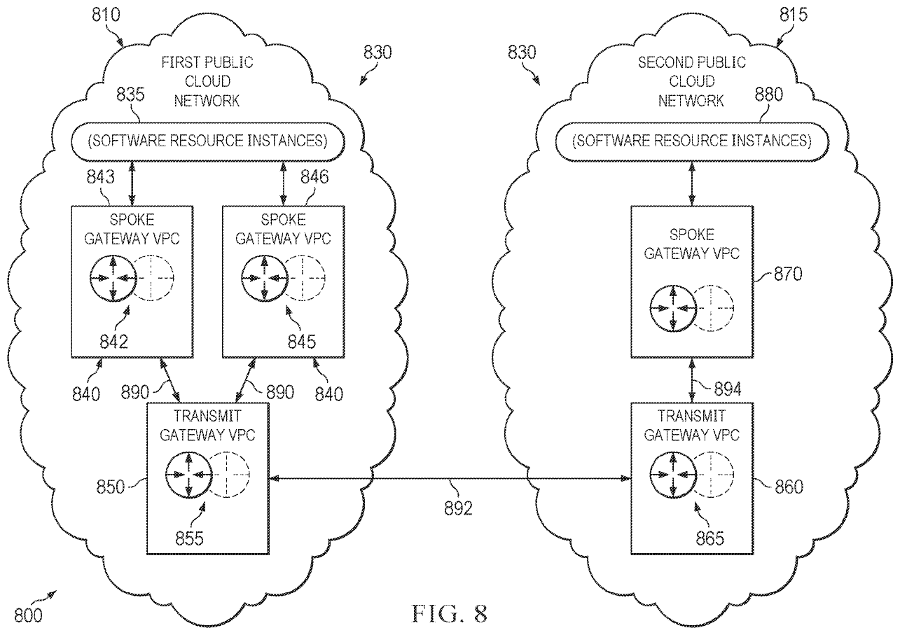

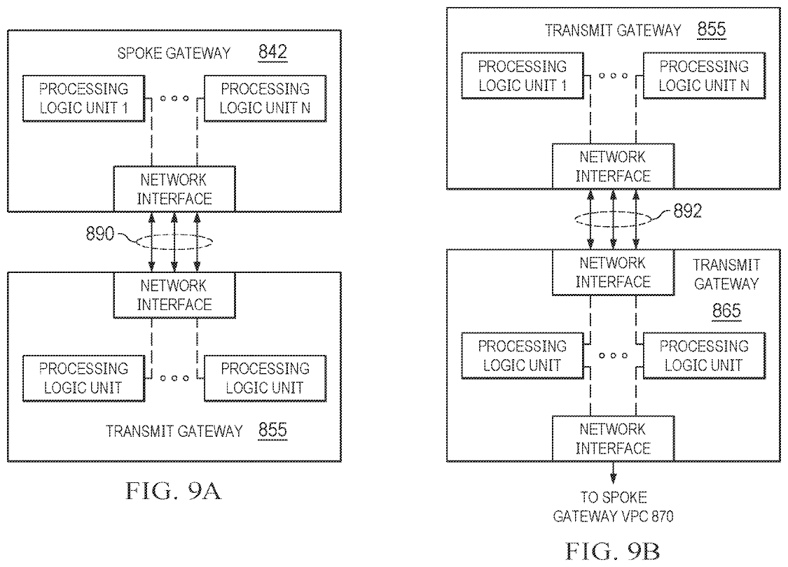

In accordance with a third embodiment of the disclosure, FIGS. 8-9 provide representative diagrams of an illustrative deployment for the high-performance communication link within an overlay network bridging two different public cloud networks. For this embodiment, each spoke subnetwork (subnet) includes a plurality of spoke gateways, which operate as ingress (input) and/or egress (output) points for network traffic sent over the overlay network that may span across a single public cloud network or may span across multiple public cloud networks (referred to as a “multi-cloud overlay network”). More specifically, the overlay network may be deployed to support communications between different VPCs within the same public cloud network or different public cloud networks. For clarity and illustrative purposes, however, the overlay network is described herein as a multi-cloud overlay network that supports communications between different networks, namely different VPCs located in different public cloud networks.

### I. TERMINOLOGY

In the following description, certain terminology is used to describe features of the

invention. In certain situations, each of the terms “computing device” or “logic” is representative of hardware, software, or a combination thereof, which is configured to perform one or more functions. As hardware, the computing device (or logic) may include circuitry having data processing, data routing, and/or storage functionality. Examples of such circuitry may include, but are not limited or restricted to a processing logic unit (e.g., microprocessor, one or more processor cores, a programmable gate array, a microcontroller, an application specific integrated circuit, etc.); non-transitory storage medium; a superconductor-based circuit, combinatorial circuit elements that collectively perform a specific function or functions, or the like.

Alternatively, or in combination with the hardware circuitry described above, the computing device (or logic) may be software in the form of one or more software modules. The software module(s) may be configured to operate as one or more software instances with selected functionality (e.g., virtual processing logic unit, virtual router, etc.), a virtual network device with one or more virtual hardware components, or an application. In general, the software module(s) may include, but are not limited or restricted to an executable application, an application programming interface (API), a subroutine, a function, a procedure, an applet, a servlet, a routine, source code, a shared library/dynamic load library, or one or more instructions. The software module(s) may be stored in any type of a suitable non-transitory storage medium, or transitory storage medium (e.g., electrical, optical, acoustical, or other form of propagated signals such as carrier waves, infrared signals, or digital signals). Examples of non-transitory storage medium may include, but are not limited or restricted to a programmable circuit; a superconductor or semiconductor memory; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device.

One type of component may be a cloud component, namely a component that operates as part of a public cloud network. Cloud components may be configured to control network traffic by restricting the propagation of data between cloud components of a multi-cloud network such as, for example, cloud components of a multi-cloud overlay network or cloud components operating as part of a native cloud infrastructure of a public cloud network (hereinafter, “native cloud components”).

Processing logic unit: A “processing logic unit” is generally defined as a physical or virtual component that performs a specific function or functions such as processing of data and/or assisting in the propagation of data across a network. Examples of the processing logic unit may include a processor core (virtual or physical), or the like.

Controller: A “controller” is generally defined as a component that provisions and manages operability of cloud components over a multi-cloud network (e.g., two or more public cloud networks), along with management of the operability of a virtual networking infrastructure. According to one embodiment, the controller may be a software instance created for a tenant to provision and manage the multi-cloud overlay network, which assists in communications between different public cloud networks. The provisioning and managing of the multi-cloud overlay network is conducted to manage network traffic, including the transmission of data, between components within different public cloud networks.

Tenant: Each “tenant” uniquely corresponds to a particular customer provided access to the cloud or multi-cloud network, such as a company, individual, partnership, or any group of entities (e.g., individual(s) and/or business(es)).

Computing Device: A “computing device” is generally defined as a particular component or collection of components, such as logical component(s) with data processing, data routing, and/or data storage functionality. Herein, a computing device may include a software instance configured to perform functions such as a gateway (defined below).

Gateway: A “gateway” is generally defined as virtual or physical logic with data monitoring and/or data routing functionality. As an illustrative example, a first type of gateway may correspond to virtual logic, such as a data routing software component that is assigned an Internet Protocol (IP) address within an IP address range associated with a virtual networking infrastructure (VPC) including the gateway, to handle the routing of messages to and from the VPC. Herein, the first type of gateway may be identified differently based on its location/operability within a public cloud network, albeit the logical architecture is similar.

For example, a “spoke” gateway is a gateway that supports routing of network traffic between component residing in different VPCs, such as an application instance requesting a cloud-based service and a VPC that maintains the cloud-based service available to multiple (two or more) tenants. A “transit” gateway is a gateway configured to further assist in the propagation of network traffic (e.g., one or more messages) between different VPCs such as different spoke gateways within different spoke VPCs. Alternatively, in some embodiments, the gateway may correspond to physical logic, such as a type of computing device that supports and is addressable (e.g., assigned a network address such as a private IP address).

Spoke Subnet: A “spoke subnet” corresponding to a type of subnetwork being a collection of components, namely one or more spoke gateways, which are responsible for routing network traffic between components residing in different VPCs within the same or different public cloud networks, such as an application instance in a first VPC and a cloud-based service in a second VPC that may be available to multiple (two or more) tenants. For example, a “spoke” gateway is a computing device (e.g., software instance) that supports routing of network traffic over an overlay network (e.g., a single cloud overlay network or multi-cloud overlay network) between two resources requesting a cloud-based service and maintaining the cloud-based service. Each spoke gateway includes logic accessible to a gateway routing data store that identifies available routes for a transfer of data between resources that may reside within different subnetworks (subnets). Types of resources may include application instances and/or virtual machine (VM) instances such as compute engines, local data storage, or the like.

Transit VPC: A “transit VPC” may be generally defined as a collection of components, namely one or more transit gateways, which are responsible for furthering assisting in the propagation of network traffic (e.g., one or more messages) between different VPCs, such as between different spoke gateways within different spoke subnets. Each transit gateway allows for the connection of multiple, geographically dispersed spoke subnets as part of a control plane and/or a data plane.

Interconnect: An “interconnect” is generally defined as a physical or logical connection between two or more computing devices. For instance, as a physical interconnect, a wired and/or wireless interconnect in the form of electrical wiring, optical fiber, cable, bus trace, or a wireless channel using infrared, radio frequency (RF), may be used. For a logical interconnect, a set of standards and protocols is followed to generate a secure connection (e.g., tunnel or other logical connection) for the routing of messages between computing devices.

Computerized: This term and other representations generally represents that any corresponding operations are conducted by hardware in combination with software.

Message: Information in a prescribed format and transmitted in accordance with a suitable delivery protocol. Hence, each message may be in the form of one or more packets (e.g., data plane packets, control plane packets, etc.), frames, or any other series of bits having the prescribed format.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

### II. FIRST COMMUNICATION LINK ARCHITECTURE & COMMUNICATION SCHEME

Referring to FIG. 1A, an exemplary embodiment of the architecture and communication scheme utilized by a high-performance communication link 100 supporting communications between computing devices 110 and 120 is shown. Each of the computing devices 110 and 120 include a network interface 115 and 125, respectively. The network interfaces 115 and 125 are configured to transmit and/or receive data routed via the communication link 100, where each of the network interfaces 115 and 125 may constitute or at least include a network interface controller (NIC) for example. Although not shown in FIG. 1, each of the network interfaces 115 and 125 are configured with a number of queues (N, M) each dedicated to a specific processing logic unit (PLU) 140₁-140_{N} and 150₁-150_{M}, respectively.

According to one embodiment of the disclosure, the communication link 100 is created as a collection of interconnects 130, which may correspond in a number that exceeds the number of queues (N or M) between computing devices 110 and 120. The interconnects (e.g., interconnects 130₁-130_{R}, where R≥M-or-N) provide communications between processing logic units 140₁-140_{N} and/or 150₁-150_{M} residing in different computing devices 110 and 120. For example, a first interconnect 130₁ may provide communications between a first processing logic unit 140₁ of the first computing device 110 and a second processing logic unit 150₂ and its corresponding queue deployed the second computing device 120.

As an illustrative example, each of the interconnects 130₁-130_{R} may constitute an Internet Protocol Security (IPSec) tunnel created as part of the communication link 100. Furthermore, each interconnects 130₁-130_{R} may be represented to a processing logic unit as a virtual interface. As a result, the first computing device 110 communicates with the second computing device 120 as if the first computing device 110 is communicatively coupled to different servers in lieu of a single computing device.

Therefore, as shown in FIGS. 1A-1B, the first computing device 110, when transmitting data traffic 160 (e.g., one or more messages referred to as “message(s)”) from a resource 170 over the communication link 100, transmits the message(s) 160 to a selected virtual interface that operates as a termination point for a selected interconnect (e.g., first interconnect 130₁). Prior to propagating over the first interconnect 130₁, a network interface controller (NIC) 180, being part of the first network interface 115, may be configured to substitute an actual port number within meta-information 165 of the message(s) 160 with a logical port identifier (LP) prior to transmission over the high-performance communication link 100.

According to one embodiment of the disclosure, the NIC 180 may be configured to conduct a hash computation on one or more selected parameters of the message(s) 160 to generate the logical port identifier (LP) 195 to be included as part of the meta-information 165 within the message(s) 160. The message(s) 160 is subsequently output from the first computing device 110 over the high-performance communication link 100 via a selected interconnect 130₁. The meta-information 165 may be a 5-tuple header for the message 160 as shown in FIG. 1B. The logical port identifier (LP) 195 may be substituted for the destination port identifier 166 or the source port identifier 167. Herein, the destination port identifier 166 or the source port identifier 167 may constitute a logical (ephemeral) port number to provide entropy in the selection of one of the NIC queues and processing logic units 150₁-150_{M} associated with the second computing device 120.

Alternatively, according to another embodiment of the disclosure, the NIC 180 may be configured to access a data store 175, which features a listing of logical port identifiers along with intended queues and/or processing logic unit 150₁ . . . or 150_{M}. These logical port identifiers represent logical ports within a specified port number range that, when included as a destination port or source port within the meta-information 165 of the message(s) 160 in transit, are routed by a NIC 190, operating as part of the second network interface 125, to a specific processing logic unit 150₁ . . . or 150_{M} within the second computing device 120. In particular, the NIC 190 utilizes the logical (ephemeral) port identifier in determining a processing logic unit 150ᵢ (1≤i≤M) to receive the message(s) 160. The data store 175 may be populated by monitoring prior transmissions and updating the data store 175 or based on data updates/uploads learned from prior analytics.

As described herein, the usage of logical ports (source or destination) may be used to provide entropy in the selection of one of the processing logic units 150₁-150_{M} associated with the second computing device 120. In advance, the hash algorithm can be tested in order to determine which logical ports will correspond or provide a communication path to which NIC queue. As a result, logical ports can be selected in advance for subsequent direction of data traffic to a wide variety of the processing logic units 150₁-150_{M} at the second (destination) computing device 120. Without such advance testing, the number of IPSec tunnels may exceed the number of NIC queues and/or processing logic units 150 to allow for tuning of the interconnects 130₁-130_{R} to ensure that the appropriate interconnects directed to each individual NIC queue is provided.

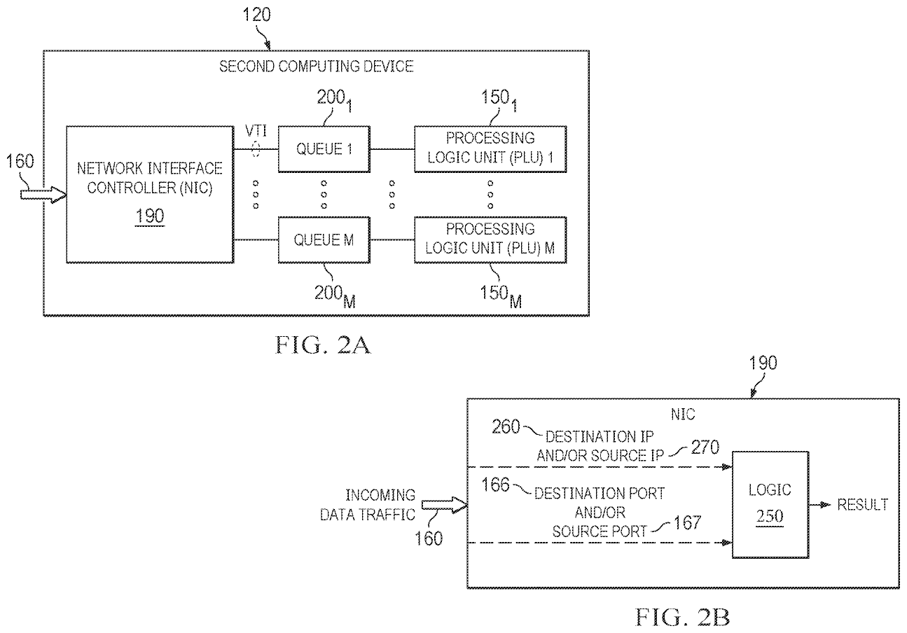

Referring now to FIG. 2A, an exemplary embodiment of the NIC 190 interacting with a plurality of (NIC) queues 200₁-200_{M} and processing logic units 150₁-150_{M} deployed within the second computing device 120 of FIG. 1A is shown. Herein, each of the NIC queues 200 . . . , or 200_{M} is dedicated to at least a processing logic unit 150₁ . . . or 150_{M} deployed within the second computing device 120. A similar architecture may be structured for the NIC 180 operating to control a flow of data from/to processing logic units 140₁-140_{N} of the first computing device 110. Herein, the processing logic units 140₁-140_{N} and/or 150₁-150_{M} may be virtual processing logic units, which are configured to process data associated with its corresponding NIC queues.

Referring to FIG. 2B, an exemplary embodiment of logic 250 deployed within the NIC 190 that performs operations on meta-information 165, which is included as part of the message(s) 160 forming incoming data traffic and is processed to determine an intended queue to receive the incoming data traffic, is shown. Herein, the logic 250 is configured to identify a correlation between results produced from operations conducted on at least a portion of the meta-information 165, inclusive of a logical (ephemeral) source port or a logical (ephemeral) destination port, to determine a queue targeted to receive the message(s). According to one embodiment of the disclosure, as shown, the logic 250 may be configured to utilize the logical source or destination port (or a representation of the same such as hash value based on the logical source or destination port) as a look-up to determine the targeted queue to receive the data traffic. As another alternative embodiment, the logic 250 may be configured to perform operations on the portion of the meta-information 165, inclusive of a logical (ephemeral) source port or a logical (ephemeral) destination port, to generate a result that may be used as a look-up to determine a queue corresponding to the result (or a portion thereof).

According to one illustrative embodiment, the NIC 190 may be adapted to receive meta-information 165 (being part of the addressing information associated with the message(s) 160). The meta-information 165 may include, but is not limited or restricted to, a destination network address 260, a destination port 166, a source network address 270, and/or the source port 167. The NIC 190 may be configured to conduct a process, where the results from the process may be used as a look-up, index or selection parameter for the NIC queues 200₁-200_{M} selected to receive the contents of the message(s) 160. The NIC queues 200₁-200_{M} operate as unique storage for the processing logic units 150₁-150_{M}, respectively.

Referring now to FIG. 3, a first exemplary embodiment of a message flow 300 over the interconnects 130₁-130₁₆ (R=16) forming the high-performance communication link 100 of FIG. 1A is shown, where NIC queue assignment is based on the particular logical source network ports. Herein, the first computing device 110, operating as the source computing device, is responsible for selection of one of the processing logic units 150₁ . . . or 150_{M} for receipt and transmission of the contents of the message(s) 160. Hence, the first computing device 110 is configured and responsible for selection and/or generation of a logical (ephemeral) source port.

As shown, a first processing logic unit 140₁ of the processing logic units 140₁-140_{N} associated with the first computing device 110 generates the message(s) 160 with a peer destination IP address (CIDR 10.2.0.1) being the IP address of the second computing device 120 and a peer source IP address (CIDR 10.1.0.1) being the IP address for the first computing device 110. Additionally, in lieu of the first computing device 110 using source port 4500 for Transmission Control Protocol (TCP) transmissions, a logical (ephemeral) source port 310 is utilized for message(s) 160 from the first computing device 110. The utilization of different logical source port identifiers (4501-4516) in lieu of the actual port number (4500) permits the NIC 190 to conduct load balancing operations on data traffic 160 transmitted across interconnects 130₁-130_{R} and usage of different processing logic units 150₁-150_{M}.

As an illustrative example, as shown in FIG. 3, the (source) NIC 180 is configured to

receive message(s) 160 from the first processing logic unit 140₁, where the meta-information 165 associated with the message(s) 160 includes peer destination IP address (CIDR 10.2.0.1) 320 and the peer source IP address (CIDR 10.1.0.1) 330. Herein, the destination port 340 and the source port 350 are identified by the actual destination port (e.g., 4500 port). To provide scaling for communications that allow transmissions beyond 1 gigabit per second (Gbps) found in conventional IPSec communication links, the NIC 180 leverages targeted direction of data traffic for processing toward different processing logic units 150₁-150_{M} of the second (destination) computing device 120 by assigning a logical source port identifier (4501 . . . 4516) to meta-information 165 of each of the message(s) 160 forming the data traffic. The logical source port identifiers, when analyzed by the NIC 190, cause redirection of the message(s) to a particular NIC queues 200₁-200_{M} corresponding to the processing logic units 150₁-150_{M}. As shown, the logical source port identifier 4501 may cause the workload to be directed to the first processing logic units 150₁ while the logical source port identifier 4503 may be directed to the second processing logic units 150₂, and the like. In summary, the utilization of “R” IPSec tunnels (e.g., R=16) through dynamic logical source port selection allows for increased data throughput.

Referring to FIG. 4, a second exemplary embodiment of a message flow 400 over the interconnects 130₁-130_{R} forming the high-performance communication link 100 of FIG. 1A is shown, where NIC queue assignment is based on generation of different logical destination ports. Herein, the NIC 180 of the first computing device 110 performs no operations on the peer destination IP address (CIDR 10.2.0.1) 320, the peer source IP address (CIDR 10.1.0.1) 330 and the source port 350 for message(s) 160 in transit to the second computing device 150.

However, the destination port 340 may be altered, where the alteration influences the routing of the message(s) 160 to specific processing logic units 150₁-150_{M}. The NIC 190 deployed at the second computing device 120 is responsible, based on detection of a first logical destination port identifier (4501), directed the message(s) 160 to the first NIC queue 200₁ for processing by the first processing logic unit 150₁ of the second computing device 120. Similarly, the NIC 190 is responsible for directing message(s) 160 to other NIC queues 200₂-200_{M} based on the assigned logical destination port identifier (4502-4516, where “M”=16). The use of logical (ephemeral) port identifiers is handled on the received side for redirecting data traffic to saturate the NIC queues to increase the throughput rate of the communication link 100.

### III. Second Communication Link Architecture & Communication Scheme

Referring to FIG. 5, an exemplary logical representation of a second embodiment of the architecture and communication scheme utilized by the high-performance communication link 100 of FIG. 1A, as perceived by the computing devices 110 and 120, is shown. Herein, source network address translation (NAT) logic 500 and destination NAT logic 510 collectively support the distribution of the data traffic 160 (e.g., message(s)) across the high-performance communication link 100 to multiple processing logic units 150₁-150_{M} for increased data throughput. More specifically, from a logical perspective, the source NAT logic 500 operates so that each source processing logic unit 140₁-140_{N} perceives that they are connecting to computing devices each associated with different, ephemeral destination IP addresses 520. These destination IP addresses 520 are represented by a CIDR 100.64.0.x, where the least significant octet (x) represents a unique number for use in selecting one of the processing logic unit 150₁-150_{M}.

As shown in FIG. 5, the first computing device 110 associated with a first source network address 530 (e.g., CIDR 10.1.0.1) and “4500” destination network port identifier 535 perceives that data traffic 160 is directed to a range of destination IP addresses (e.g., CIDR 100.64.0.x) 540, where the least significant octet (x) represents a unique number for use in identifying one of the processing logic unit 150₁-150_{M}.

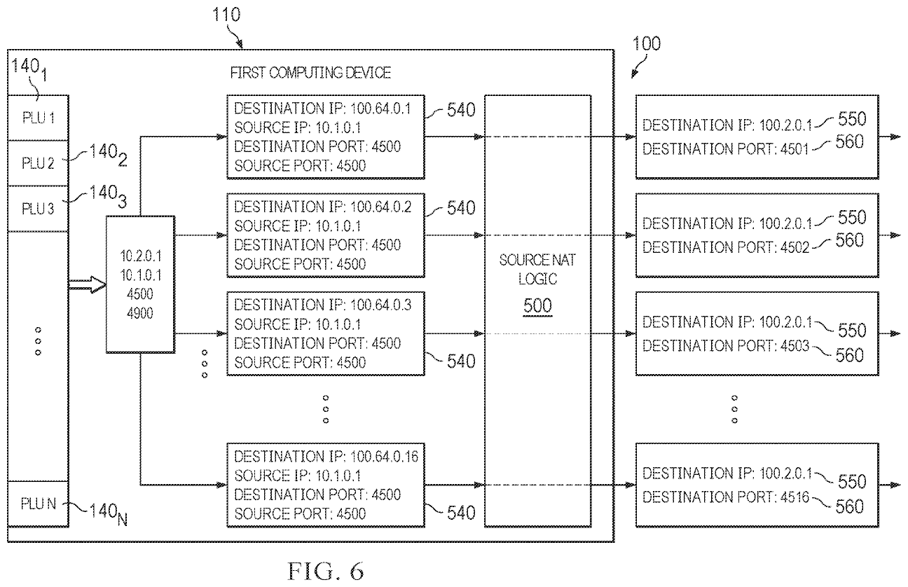

More specifically, as shown in FIG. 6, an exemplary embodiment of the operability of the source NAT logic 500 of the first (source) computing device 110 supporting the first high-performance communication link 100 of FIG. 5 is shown. Herein, the source NAT logic 500 operates as a process within or a separate process from the NIC. For handling outgoing data traffic, the source NAT logic 500 may be configured with access to one or more data stores to conduct the translation of the <100.64.0.X> ephemeral destination IP addresses 540 into peer IP addresses 550 (e.g., CIDR 10.2.0.1) with a logical destination port equivalent to the actual port (e.g., 4500) that is adjusted based on the least significant octet X. For example, the destination IP address 10.64.0.3 and a destination port identified “4500” may be translated into peer IP address 10.2.0.1 with a destination port identifier “4503”. This translation may be used as a means for substituting the actual destination port “4500” with a logical destination port identifier '4503“.

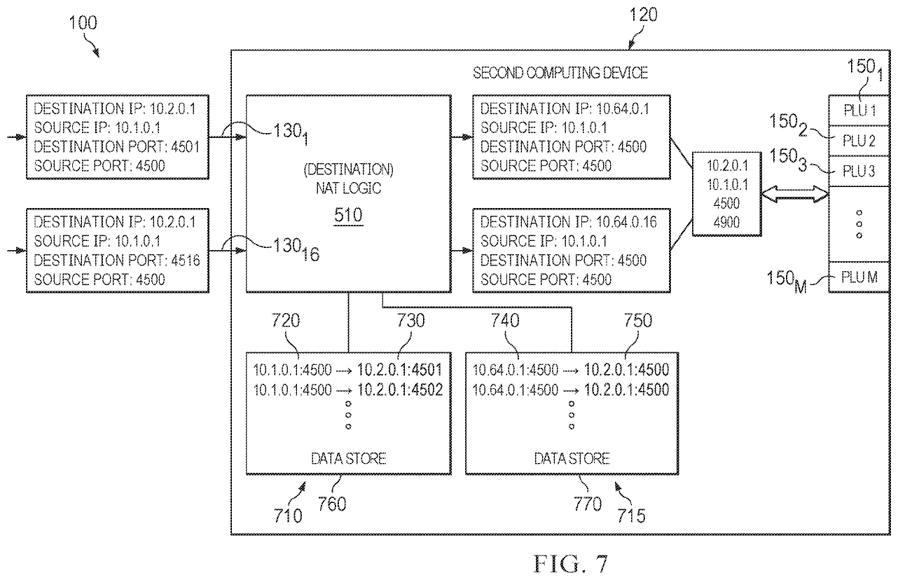

As shown in FIG. 7, an exemplary embodiment of the operability of destination NAT logic 510 deployed as part of the second (destination) computing device 120 and supporting the first high-performance communication link 100 of FIG. 5 is shown. Herein, for handling incoming data traffic 700, the destination NAT logic 510 may be configured with access to one or more data stores 760 and 770, which are configured to maintain (i) a first mapping 710 between peer IP address/logical port combinations 720 and their corresponding ephemeral network address/actual port combinations 730 and (ii) a second mapping 715 between the ephemeral, destination IP address/actual port combinations 740 and the destination peer IP address/actual port combinations 750. Additionally, although not shown, for handling outgoing data traffic 700, the destination NAT logic 510 may be configured with access to a mapping between logical ports and their specific processing logic unit (or NIC queue at a destination). This address translation scheme allows communications over the high-performance communication link 100 to rely on a single IP address assigned to the destination computing device 120 despite multiple interconnects 130₁-130_{R} (e.g., IPSec tunnels, R=16), with the actual source port and/or destination port identifier being substituted with a logical source port identifier and/or a logical destination port identifier to assist in processing logic unit selection at the destination computing device 120.

### IV. Overlay Network With High-Performance Communication Links

Referring now to FIG. 8, an exemplary embodiment of an overlay network 800 deployed as part of a multi-cloud network including high-performance communication links between one or more spoke gateways and a transit gateway is shown. Herein, a first public cloud network 810 and a second public cloud network 815 are communally coupled over an overlay network 800. The overlay network 800 allows for and supports communications within different public cloud networks 810 and 815 associated with a multi-cloud network 830.

According to one embodiment of the disclosure, the overlay network 800 is configured to provide connectivity between resources 835, which may constitute one or more virtual machine (VM instances), one or more application instances or other software instances. The resources 835 are separate from the overlay network 800. The overlay network 800 may be adapted to include at least a first spoke gateway VPC 840, a first transit gateway VPC 850, a second transit gateway VPC 860, and at least a second spoke gateway VPC 870. The second transit gateway VPC 860 and the second spoke gateway VPC 870 may be located in the second public cloud network 815 for communication with local resources 880 (e.g., software instance).

For redundancy purposes, two or more spoke gateways 842 may be associated with a first spoke gateway VPC 843 while a plurality of spoke gateways 845 may be associated with another spoke gateway VPC 846. The spoke gateways 842 and 845 are communally coupled to the transit gateways 855 over a first high-performance communication link 890. In particular, each spoke gateway may correspond to the first computing device 110 of FIG. 1A while the transit gateway 855 may correspond to the second computing device 120 of FIG. 1A. Herein, the first transit gateways 855 are communally coupled via a second high-performance communication link 892 to transit gateways 865 of the second transit gateway VPC 860. Likewise, a third high-performance communication link 894 is communally coupled to the spoke gateway VPC(s) 870. The high-performance communication links 890, 892 and 894 operate in a similar fashion as multiple interconnects that provide for dedicated communications with a NIC queue and its corresponding processing logic unit that is responsible for processing the data stored in the NIC queue.

Referring to FIG. 9A, an exemplary embodiment of the operability of the first high- performance communication link 890 of FIG. 8 deployed as part of the overlay network 800 of FIG. 8 between the first computing device operating as the first spoke gateway 842 and the second computing device operating as the first transit gateway 855 is shown. Herein, the first high-performance communication link 890 is configured to provide multiple interconnects to corresponding processing logic units assigned to the spoke gateway 842 and the transit gateway 855.

In addition, the transit gateway features a second set of processing logic units and corresponding NIC queues (not shown) to provide for communications over high-performance communication link 892 with the second transit gateway 865 as shown in FIG. 9B. The configuration of the transit gateway 855 relies upon a set of processing logic units to support each individual high-performance communication link 890 and 892.

Embodiments of the invention may be embodied in other specific forms without departing from the spirit of the present disclosure. The described embodiments are to be considered in all respects only as illustrative, not restrictive. The scope of the embodiments is, therefore, indicated by the appended claims rather than by the foregoing description. All changes that come within the meaning and range of equivalency of the claims are to be embraced within their scope.

What is claimed is:

1. A high-performance communication link connecting a first computing device and a second computing device, the communication link comprising a plurality of interconnects between the first computing device and the second computing device, wherein the plurality of interconnects are configured in accordance with a secure network protocol that tunnels data over different ports to achieve increased aggregated throughput.

2. The high-performance communication link of claim 1, wherein the first computing device and the second computing device each comprises at least one network interface, and further wherein the at least one network interface includes at least one network interface controller.

3. The high-performance communication link of claim 2, wherein the at least one network interface of the first computing device and the second computing device is configured with a number of queues.

4. The high-performance communication link of claim 3, wherein the number of interconnects exceeds the number of queues between the first computing device and the second computing device.

5. The high-performance communication link of claim 2, wherein the at least one network interface controller of the second computing unit is configured to receive data traffic addressed by a destination IP address assigned to the second computing device.

6. The high-performance communication link of claim 1, wherein the first computing device transmits data traffic from a resource to a selected virtual interface that operates as a termination point for a selected interconnect.

7. The high-performance communication link of claim 2, wherein the at least one network interface controller of the first computing device is configured to substitute an actual port number within meta-information of the data with a logical port identifier.

8. The high-performance communication link of claim 7, wherein the meta-information is a 5-tuple header.

9. The high-performance communication link of claim 2, wherein the at least one network interface controller of the first computing device is configured to access a data store that features a listing of logical port identifiers along with intended queues and/or processing logic unit.

10. The high-performance communication link of claim 9, wherein the logical port identifiers represent logical ports within a specified port number range that are routed by the at least one network interface controller of the second computing device to a processing logic unit within the second computing device.

11. The high-performance communication link of claim 2, wherein the at least one network interface controller of the second computing device interacts with a plurality of queues and processing logic units deployed within the second computing device.

12. The high-performance communication link of claim 2, wherein the at least one network interface controller of the second computing device deploys a logic that performs operations on meta-information included as part of the incoming data traffic and is processed to determine an intended queue to receive the incoming data traffic.

13. The high-performance communication link of claim 12, wherein the meta-information is selected from a destination network address, a destination port, a source network address or a source port.

14. The high-performance communication link of claim 12, wherein the logic is configured to identify a correlation between results produced from operations conducted on at least a portion of the meta-information.

15. The high-performance communication link of claim 12, wherein the logic is configured to utilize the logical source or destination port as a look-up to determine the targeted queue to receive the data traffic.

16. The high-performance communication link of claim 12, wherein the logic is configured to perform operations on the portion of the meta-information to generate a result that may be used as a look-up to determine a queue corresponding to the result.

17. The high-performance communication link of claim 1, wherein the first computing device operates as a source computing device and is responsible for selection of a processing logic unit for receipt and transmission of the data.

18. The high-performance communication link of claim 1, wherein the first computing device comprises source network address translation logic and the second computing device comprises destination network address translation logic, and further wherein the source network address translation logic and the destination network translation logic collectively support the distribution of data traffic across the high-performance communication link.

19. The high-performance communication link of claim 18, wherein the source network address translation logic operates so that each source processing logic unit perceives that they are connecting to computing devices each associated with different, ephemeral destination IP addresses.

20. The high-performance communication link of claim 18, wherein the destination network address translation logic is configured with access to one or more data stores that are configured to maintain (i) a first mapping between peer IP address/logical port combinations and their corresponding ephemeral network address/actual port combinations and (ii) a second mapping between the ephemeral, destination IP address/actual port combinations and the destination peer IP address/actual port combinations.
